(19) United States
(12) Patent Application Publication
(10) Pub. No.: US 2020/0124402 A1
(43) Pub. Date: Apr. 23, 2020

(54) Slab nozzle inspection equipment with artificial measurement error avoidance

(71) Applicant: Wanli Chen, Dongguan City (CN)

(72) Inventor: Wanli Chen, Dongguan City (CN)

(21) Appl. No.: 16/721,930

(22) Filed: Dec. 20, 2019

(30) Foreign Application Priority Data
Aug. 27, 2019 (CN) 2019107967460

(51) Int. Cl. G01B 11/06; B05B 12/12; B22D 2/00

(52) U.S. Cl. CPC G01B 11/0691; B22D 2/00; B05B 12/122

(57) ABSTRACT

The invention discloses a slab nozzle inspection equipment with artificial measurement error avoidance, and includes a left-right symmetrical extension slide rail, the extension slide rail is provided with a slide cavity opening downward and facing the symmetrical center side, and the slide cavity is provided with a translation device. The present invention uses a horizontally moving measurement structure to control the marking device. Through the structure of gear meshing rotation, a stable and reliable transmission is formed. The color of the paint is selected by the power of rotation. According to the different colors on the plate, the thickness of the plate is distinguished, and the length of the same color segment is determined. The length of the plate at the higher thickness, if the paint marks of different stages and different colors appear, it proves that the thickness of the slab material is gradually increasing, which is convenient for subsequent processing.

### CROSS-REFERENCES TO RELATED APPLICATIONS

The present application claims priority from Chinese application No. 2019107967460 filed on Aug. 27, 2019 which is hereby incorporated by reference in its entirety.

### FIELD OF TECHNOLOGY

The invention relates to the technical field of slab measurement, and in particular relates to a slab nozzle inspection equipment with artificial measurement error avoidance.

### TECHNICAL FIELD

The continuous casting tundish immersion nozzle is the key refractory material connected between the tundish and the mold. The shape, outlet angle and bottom structure size of the submerged nozzle directly affect the use of the tundish nozzle. The slight difference in the size of the nozzle will cause the quality of the slab continuous casting slab to fluctuate, which will directly cause the vicious accident of steel leakage, causing huge economic losses and hidden safety hazards. The slabs are made by complete sheet bending. Therefore, it is very important to determine the thickness of the sheet in the processing cavity. Traditional vernier calipers can only perform point measurement, the data is not comprehensive, and the reading process is complex and easy to read. A device capable of solving the above problems.

### CONTENT OF THE INVENTION

Technical problem: traditional vernier calipers can only measure the thickness of the slab material by stepping on the points. The data is not comprehensive, and the reading process is complex and easy to read.

In order to solve the above problem, a slab nozzle size inspection instrument for reducing artificial measurement error is designed in this example, and a slab nozzle size inspection instrument for reducing artificial measurement error in this example includes a left-right symmetrical extension slide rail. The slide rail is provided with a slide cavity opening downward and facing the center of symmetry. The slide cavity is provided with a translation device. The translation device can communicate with the slide groove through the inner wall of the slide cavity. A slide bar slidingly connected to the slide groove uses the inner wall of the slide groove to restrict the smooth slide of the slide bar. A suspension bar is fixed on the slide bar, and a marking box is fixed at the lower end of the suspension bar. There is a marking cavity, and a measuring device for sliding detection of the surface of the plate is provided in the marking cavity. The measuring device can pass a right-angle rod slidingly connected to the inner wall of the bottom end of the marking cavity, and a ball slidingly connected to the lower end of the right-angle rod. Using the contact between the ball and the plate to change the position of the right-angle rod in real time, a transmission shaft extending up and down is connected in rotation in the marking cavity, and a color selection device is provided on the transmission shaft, The color selection device can be provided by a turntable provided on the transmission shaft, and an annular array is arranged in eight receiving slots on the turntable. The receiving slot is used to load different colors of paint. A supplementary device at the upper end of the turntable. The supplementary device can be circularly distributed in the seven storage chambers on the storage disc through a storage disc rotatably connected to the transmission shaft, and is slidably connected to the storage chamber and runs through the storage chamber. The through hole of the storage cavity uses the storage cavity to store the paint, and the up and down sliding of the through hole is used for pigment replenishment. The extension slide rail is fixedly provided with a bracket on the end face away from the symmetrical center end, and a clamping device is provided on the lower end of the bracket.

Preferably, the storage cavity corresponds to the upper and lower positions of the receiving slot, and the upper end of the receiving slot on the far left corresponds to a position where the storage disc does not have the storage cavity.

Preferably, the size of the slide cavity on the left side is equal to the size of the extended slide rail on the right side.

Preferably, the sliding grooves on the left and right sides are located on the same horizontal line.

Preferably, the inner wall of the bottom end of the marking cavity is provided with a delivery tube connected to the leftmost end of the receiving groove.

Wherein, the measuring device includes a fixed shaft rotatably connected to the inner wall of the front side of the marking cavity, and the fixed shaft is provided with a bevel-toothed turntable which is meshed with the right-angle rod, and the horizontal end portion of the right-angle rod is connected with the A reset spring is connected between the inner walls of the bottom end of the marking cavity.

The color selection device includes a bevel gear disposed on the transmission shaft and meshed with the bevel-toothed turntable. A symmetrical baffle is rotatably connected to the receiving groove, and a chain rod is hinged on the baffle. An abutment plate is hinged between the chain rods, and a resistance spring is connected between the chain rods.

Preferably, the transmission shaft is provided with an isolation cover located at the upper end of the bevel gear, and the isolation cover is a bowl-shaped structure with an upward opening.

Wherein, the supplementary device includes a lifting plate screwed to the transmission shaft and located at the lower end of the storage plate, the lifting plate is fixedly connected to the injection tube, and the injection tube is provided with a storage cavity The connecting end is connected with the through hole, and the lower end surface of the lifting plate is provided with a push rod capable of contacting the abutting plate.

Wherein, the clamping device includes a fixed box fixedly connected to the lower end of the bracket, the fixed box is provided with a transmission cavity, and the inner wall of the transmission cavity close to the center of symmetry is provided with a vertically symmetrical slideway. A clamping plate is slidably connected in the slideway, a compression spring is connected between the clamping plate and the slideway, a screw is rotatably connected to the inner wall of the transmission cavity away from the symmetrical center side, and a moving plate is threadedly connected to the screw. A slanting block which is slidably connected to the splint and is symmetrical on the top and bottom is fixed on the plate, and a knob is arranged on the screw outside the transmission cavity.

The beneficial effect of the present invention is that the present invention uses a horizontally moving measurement structure to control the marking device, forms a stable and reliable transmission through the gear meshing and rotating structure, and uses the power of rotation to select the color of the paint. The thickness of the plate is distinguished, and the length of the plate with a higher thickness is determined according to the length value of the same color segment. If the paint marks of different stages and different colors are displayed, it proves that the thickness of the slab material is gradually increasing. It is convenient for subsequent processing. This mode can avoid the problem that the sampling point of the vernier caliper method is small and the data is not comprehensive.

### BRIEF DESCRIPTION OF THE DRAWINGS

For ease of description, the present invention is described in detail by the following specific embodiments and the accompanying drawings.

FIG. 1 is a schematic diagram of the overall structure of a slab nozzle size inspection instrument for reducing artificial measurement errors of the present invention;

FIG. 2 is a schematic diagram of a three-dimensional structure of the “extended slide rail” of FIG. 1;

FIG. 3 is an enlarged structure diagram of a “marking box” in FIG. 1;

FIG. 4 is an enlarged structural diagram at “A” in FIG. 3;

FIG. 5 is a schematic structural diagram of the “B-B” direction of FIG. 3;

FIG. 6 is a schematic structural view in the direction of “C-C” of FIG. 3.

### DETAILED DESCRIPTION OF THE INVENTION

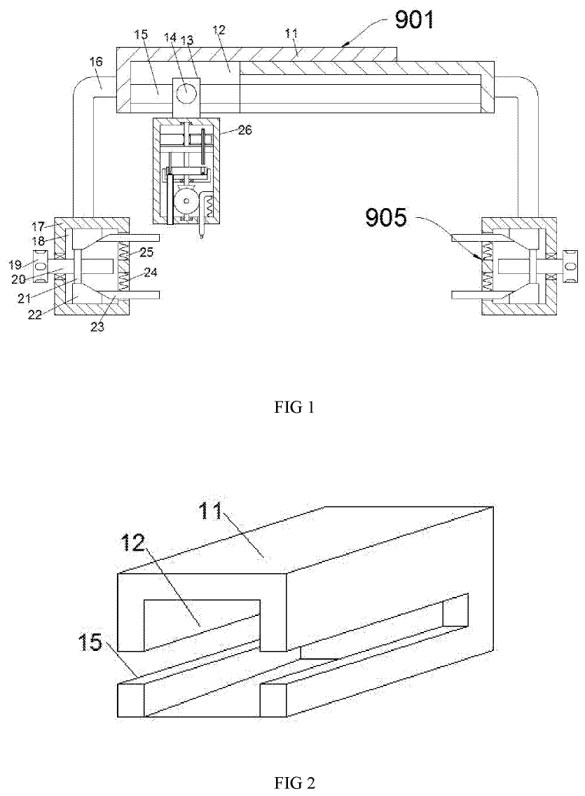

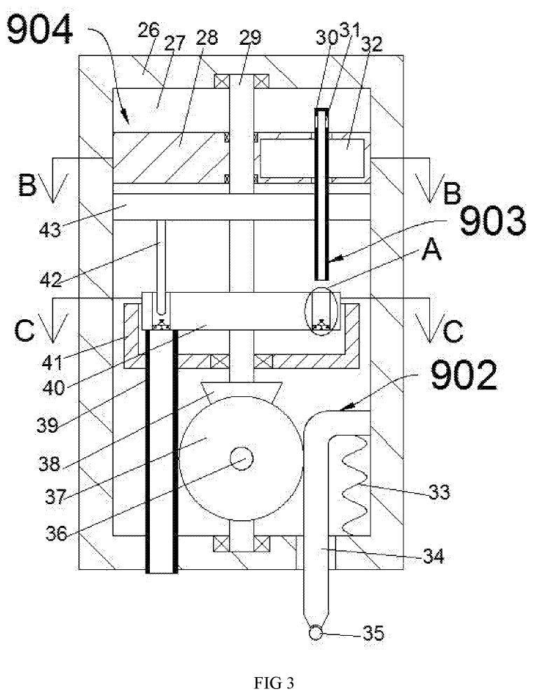

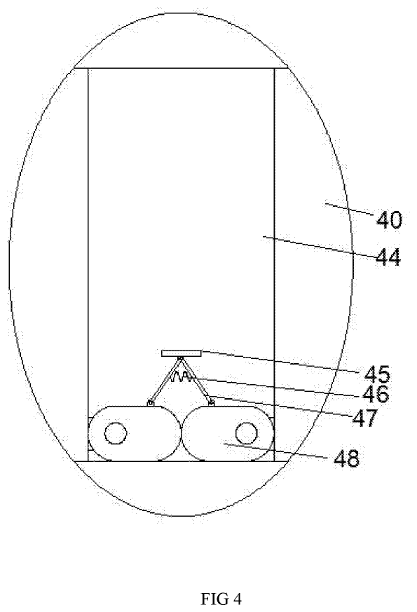

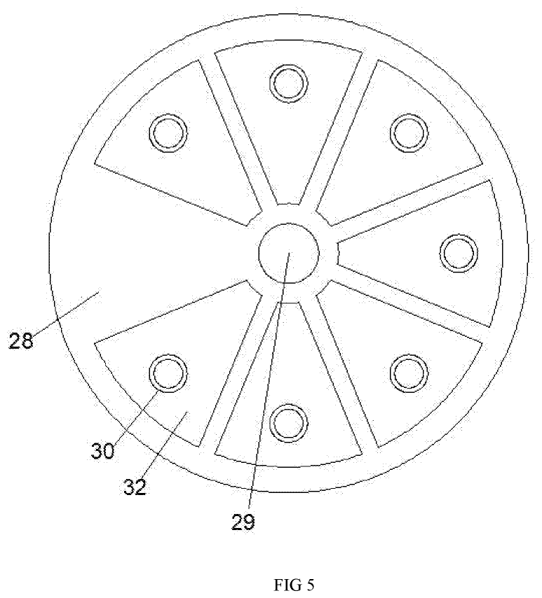

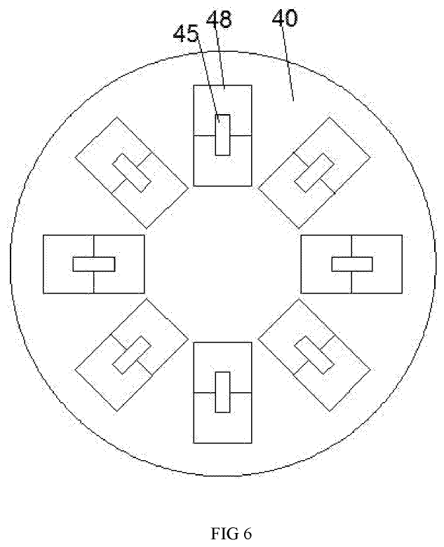

The present invention will be described in detail below with reference to FIGS. 1-6. For convenience of description, the orientation described below is defined as follows: the up-down, left-right, front-back direction described below is consistent with the up-down, left-right, front-back direction of the projection relationship of FIG.

The invention relates to a slab nozzle size inspection instrument for reducing artificial measurement errors, which is mainly used in the process of detecting the thickness of slab material. The invention will be further described below with reference to the accompanying drawings of the invention:

The slab nozzle size inspection instrument for reducing artificial measurement errors according to the present invention includes a left-right symmetrical extension slide rail 11, and the extension slide rail 11 is provided with a slide cavity 12 opening downward and facing the symmetrical center side. The slide chamber 12 is provided with a translation device 901, and the translation device 901 can pass through the slide groove 15 penetrating through the inner wall of the front and rear sides of the slide cavity 12, and the slide rod 14 slidably connected to the slide groove 15. The inner wall of the chute 15 restricts the sliding rod 14 from sliding smoothly. A hanging rod 13 is fixed on the sliding rod 14. A marking box 26 is fixed on the lower end of the hanging rod 13. A marking cavity 27 is provided in the marking box 26. A measuring device 902 for detecting the sliding of the surface of the plate is provided in the marking cavity 27. The measuring device 902 can slide with the lower end of the right-angle rod 34 through a right-angle rod 34 slidingly connected to the inner wall of the bottom end of the marking cavity 27. The connected ball 35 changes the position of the right-angle lever 34 in real time by using the contact between the ball 35 and the plate. The marking cavity 27 is rotatably connected with a transmission shaft 29 extending up and down. The transmission shaft 29 is provided with a color selection. Device 903, the color selection device 903 may Through the turntable 40 provided on the transmission shaft 29, an annular array is distributed to eight receiving grooves 44 on the turntable 40. The receiving grooves 44 are used to load different colors of paint, and the transmission shaft 29 is provided with A replenishing device 904 located at the upper end of the turntable 40, the replenishing device 904 can be circularly connected to the seven storage chambers 32 on the storage disk 28 through the storage disk 28 rotationally connected to the transmission shaft 29, and The storage cavity 32 is slidably connected and passes through the through hole 31 of the storage cavity 32. The storage cavity 32 is used to store paint, and the up and down sliding of the through hole 31 is used for pigment replenishment. The extended slide rail 11 is far from the symmetrical central end face. A bracket 16 is fixedly provided, and a clamping device 905 is provided at the lower end of the bracket 16.

Beneficially, the storage cavity 32 corresponds to the upper and lower positions of the receiving groove 44, and the upper end of the leftmost receiving groove 44 corresponds to the position where the storage disk 28 does not have the storage cavity 32, which guarantees that the structure of the equipment during work is conflict.

Beneficially, the size of the slide cavity 12 on the left side is equal to the size of the extension slide rail 11 on the right side, ensuring that the two extension slide rails 11 can slide freely and expand.

Beneficially, the sliding grooves 15 on the left and right sides are located on the same horizontal line to ensure that the height of the marking box 26 does not change during translation.

Beneficially, an inner wall of the bottom end of the marking cavity 27 is provided with a delivery pipe 39 connected to the leftmost end of the receiving groove 44 to put paint for marking.

According to an embodiment, the measurement device 902 is described in detail below. The measurement device 902 includes a fixed shaft 36 rotatably connected to the inner wall on the front side of the marking cavity 27. The fixed shaft 36 is provided with the right-angle rod 34. A bevel-toothed turntable 37 is engaged. A reset spring 33 is connected between the horizontal end portion of the right-angle rod 34 and the inner wall of the bottom end of the marking cavity 27. The resetting spring 33 assists the reset operation of the right-angle rod 34.

According to the embodiment, the color selection device 903 will be described in detail below. The color selection device 903 includes a bevel gear 38 provided on the transmission shaft 29 and meshingly connected with the bevel gear wheel 37. The receiving groove 44 A symmetrical baffle plate 48 is rotatably connected, and the baffle plate 48 is hinged with a chain rod 47. Abutment plates 45 are hinged between the chain rods 47. A resistance spring 46 is connected between the chain rods 47. The baffle plate 48 changes the opening and closing of the opening at the lower end of the receiving groove 44.

Beneficially, the transmission shaft 29 is provided with an isolation cover 41 located on the upper end of the bevel gear 38. The isolation cover 41 is a bowl-shaped structure with an upward opening, which ensures that the paint does not overflow the marking cavity 27 during the re-dispensing process.

According to the embodiment, the supplementary device 904 is described in detail below. The supplementary device 904 includes a lifting plate 43 screwed to the transmission shaft 29 and located at the lower end of the storage plate 28. The lifting plate 43 and the injection The tube 30 is fixedly connected. The injection tube 30 is provided with a connection through hole 31 that can communicate with the storage cavity 32. The lower end surface of the lifting plate 43 is provided with a push rod 42 that can abut the abutting plate 45.

According to the embodiment, the clamping device 905 is described in detail below. The clamping device 905 includes a fixing box 17 fixedly connected to the lower end of the bracket 16. A transmission cavity 18 is provided in the fixing box 17. 18 On the inner wall near the center of symmetry, there is a vertically symmetrical slideway 25. A slide plate 23 is slidably connected to the slideway 25, and a compression spring 24 is connected between the slide plate 25 and the slideway 25. The transmission A screw 20 is rotatably connected to the inner wall of the cavity 18 away from the center of symmetry, and the screw 20 is screw-connected with a moving plate 21. The moving plate 21 is fixedly provided with an inclined block 22 which is slidably connected to the clamping plate 23 and is symmetrical. The screw 20 is provided with a knob 19 located outside the transmission cavity 18.

The following describes in detail the use steps of a slab nozzle size inspection instrument in this article in conjunction with FIGS. 1 to 6 to reduce the artificial measurement error:

When fixing, place the left side fixing box 17 on the edge of the slab material, manually rotate the knob 19, and turn the screw 20 and the moving plate 21 to rotate the bevel block 22 to the symmetrical center side, and then pass the bevel block 22 and the The sliding connection between the clamping plates 23 pushes the clamping plates 23 closer to each other, fixes the clamping device 905 on the left side to the edge of the sheet, pulls the expansion slide rail 11 on the right side to move to the right, and passes the clamping device 905 on the right side through the communicating steps. fixed;

During the test, the suspension rod 13 is manually pushed to move, and the ball 35 rolls on the plate. When the thickness is different, the right-angle rod 34 is pushed up to rotate the bevel gear turntable 37 by meshing, and the bevel gear plate 37 can rotate the bevel gear by meshing. At a corresponding angle of 38, at this time, the bevel gear 38 rotates the transmission shaft 29 and drives the lifting plate 43 to move down through thread rotation. During the downward movement of the lifting plate 43, the push rod 42 pushes the abutment plate 45, and the power pushes the baffle through the chain rod 47 48 is turned over, the receiving groove 44 is opened, the pigment slides out of the delivery tube 39, and is applied on the surface of the board. At the same time, the lifting plate 43 moves down to pull the injection tube 30 down. The medical history through-hole 31 is located in the storage cavity 32. The pigment in 32 is sent to the receiving tank 44 for replenishment. When the thickness is different, the right angle rod 34 moves different distances, which in turn causes the bevel-shaped turntable 37 to rotate at different angles, which makes the turntable 40 rotate at different angles. The color is distinguished by the thickness value, and the length of the plate with the higher thickness is determined according to the length value of the same color segment, which is convenient for subsequent processing.

The beneficial effect of the present invention is that the present invention uses a horizontally moving measurement structure to control the marking device, forms a stable and reliable transmission through the gear meshing and rotating structure, and uses the power of rotation to select the color of the paint. The thickness of the plate is distinguished, and the length of the plate with a higher thickness is determined according to the length value of the same color segment. If the paint marks of different stages and different colors are displayed, it proves that the thickness of the slab material is gradually increasing. It is convenient for subsequent processing. This mode can avoid the problem that the sampling point of the vernier caliper method is small and the data is not comprehensive.

In the above manner, those skilled in the art can make various changes according to the working mode within the scope of the present invention.

1. A slab nozzle inspection equipment with artificial measurement error avoidance, including a left-right symmetrical extended slide rail; the extension slide rail is provided with a slide cavity opening downward and facing the symmetrical center side. The slide cavity is provided with a translation device. The translation device can pass through a slide groove that penetrates the inner wall of the front and rear sides of the slide cavity. The slide bar slidingly connects the slide bar to restrict the smooth slide of the slide bar by the inner wall of the slide groove. A suspension bar is fixed on the slide bar, and a marking box is fixed on the lower end of the suspension bar. A marking cavity is provided in the marking cavity, and a measuring device for sliding detection of the surface of the plate is provided in the marking cavity; the measuring device can change the position of the right-angle rod in real time by using a right-angle rod slidingly connected to the inner wall of the bottom end of the marking cavity and a ball slidingly connected to the lower end of the right-angle rod using the contact between the ball and the plate; a transmission shaft extending up and down is rotatably connected in the marking cavity. The transmission shaft is provided with a color selection device, and the color selection device can pass through a turntable provided on the transmission shaft; a circular array is distributed on the turntable. Receiving tanks, which use the receiving tanks to load paint of different colors; the transmission shaft is provided with a supplementary device located on the upper end of the turntable; the supplementary device can be circularly connected to the seven storage chambers on the storage disk through a storage disk that is rotatably connected to the transmission shaft. the storage cavity is slidably connected and passes through the through hole of the storage cavity; the storage cavity is used to store the paint, and the up and down sliding of the through hole is used to supplement the pigment; the lower end of the bracket is provided with a clamping device.

2. The slab nozzle inspection equipment with artificial measurement error avoidance according to claim 1, wherein the storage cavity corresponds to the upper and lower positions of the receiving tank, and the upper end of the receiving tank at the far left corresponds to the receiving chamber. The storage tray does not have a position for the storage cavity.

3. The slab nozzle inspection equipment with artificial measurement error avoidance according to claim 1, wherein the size of the slide cavity on the left side is equal to the size of the extended slide rail on the right side.

4. The slab nozzle inspection equipment with artificial measurement error avoidance according to claim 1, wherein the chute on the left and right sides are located on the same horizontal line.

5. The slab nozzle inspection equipment with artificial measurement error avoidance according to claim 1, characterized in that: the inner wall of the bottom end of the marking cavity is provided with a delivery pipe connected to the leftmost end of the receiving groove.

6. The slab nozzle inspection equipment with artificial measurement error avoidance according to claim 1, wherein the measuring device comprises a fixed shaft rotatably connected to the inner wall on the front side of the marking cavity, and the fixed shaft is A bevel-toothed turntable is provided which is in mesh connection with the right-angle rod, and a return spring is connected between the horizontal end portion of the right-angle rod and the inner wall of the bottom end of the marking cavity.

7. The slab nozzle inspection equipment with artificial measurement error avoidance according to claim 6, wherein the color selection device comprises a bevel gear provided on the transmission shaft and meshingly connected with the bevel tooth turntable A symmetrical baffle is rotatably connected in the receiving groove, a chain rod is hinged on the baffle, an abutment plate is hinged between the chain rods, and a resistance spring is connected between the chain rods.

8. The slab nozzle inspection equipment with artificial measurement error avoidance according to claim 7, wherein the transmission shaft is provided with an isolation cover on the upper end of the bevel gear, and the isolation cover is open upward. Pelvic structure.

9. The slab nozzle inspection equipment with artificial measurement error avoidance according to claim 1, wherein the supplementary device comprises a lifting plate that is threadedly connected to the transmission shaft and is located at the lower end of the storage plate. The lifting plate is fixedly connected to the injection tube, the injection tube is provided with a connection through hole that can communicate with the storage cavity, and the lower end surface of the lifting plate is provided with a push rod that can abut the abutting plate.
The slab nozzle size inspection instrument according to claim 1, wherein the clamping device comprises a fixing box fixedly connected to the lower end of the bracket, and a transmission is arranged in the fixing box. a cavity is provided on the inner wall of the transmission cavity near the center of symmetry, and a symmetrical slide is arranged on the inner wall. the slide is slidably connected with a clamping plate, and a compression spring is connected between the clamping plate and the slide. a screw is rotatably connected to the inner wall of the symmetrical center side, and a moving plate is screw-connected to the screw. the moving plate is fixedly provided with a slanting block which is slidably connected to the clamping plate and is symmetrical to the upper and lower sides. Knob outside transmission cavity
